(19) United States
(12) Patent Application Publication
(10) Pub. No.: US 2015/0245436 A1
(43) Pub. Date: Aug. 27, 2015

(54) Compensation of a Color Locus Shift

(71) Applicant: OSRAM OPTO SEMICONDUCTORS GMBH, Regensburg (DE)

(72) Inventors: Ales Markytan, Regensburg-Burgweinting (DE); Christian Gärtner, Regensburg (DE)

(73) Assignee: OSRAM Opto Semiconductors GmbH, Regensburg (DE)

(21) Appl. No.: 14/431,737

(22) PCT Filed: Sep. 26, 2013
(86) PCT No.: PCT/EP2013/070045

§ 371 Date: Mar. 26, 2015

(30) Foreign Application Priority Data
Aug. 27, 2012 (DE) 10 2012 217 534.2

(51) Int. Cl. H05B 33/08

(52) U.S. Cl. CPC H05B 33/0824; H05B 33/086

(57) ABSTRACT

The present invention relates to an arrangement for emitting mixed light comprising at least three diodes, comprising a first drive circuit supplying the first diode with current via a first channel, wherein the first diode is of type A, wherein type A represents a diode configured to emit green and/or green-white light, wherein the drive circuit supplies the series-connected second and third diodes with current via a second channel, wherein the second diode is of type B, wherein type B represents a diode configured to emit red light, wherein the third diode is of type C, wherein type C represents a diode configured to emit blue and/or blue-white light, wherein the drive circuit is configured to change, depending on an operating parameter of at least one diode, the current supply for the first and/or second channel so as to counteract a colour locus shift of a diode.

This patent application is a national phase filing under section 371 of PCT/EP2013/070045, filed Sep. 26, 2013, which claims the priority of German patent application 10 2012 217 534.2, filed Sep. 27, 2012, each of which is incorporated herein by reference in its entirety.

### TECHNICAL FIELD

The present invention relates to a method and to a device for compensating a color locus shift.

### BACKGROUND

The prior art teaches methods of generating a mixed light of white color by means of a plurality of diodes, the diodes being distributed to three drive channels for current supply. Diodes may exhibit a color locus shift of the emitted light, e.g., due to deterioration. By correspondingly controlling the three drive channels, the color locus shift may be compensated in such a way that the desired color locus remains essentially consistent.

### SUMMARY

An improved arrangement, particularly a simpler arrangement for emitting light, is provided in which the color locus shift in a diode may be compensated in a simple and effective manner.

An advantage of the described arrangement and of the described method is the simple configuration of the arrangement. According to the described arrangement, two drive channels are sufficient for the diodes in order to be able to compensate a color locus shift. This is possible because the used diodes may be chosen in such a way that the current is changed in a channel having at least one diode by means of a drive circuit so that the color locus shift is compensated. Thus, contrary to the prior art, it is not necessary to provide three channels, i.e., three series connections of diodes. By reducing the channels of the drive circuit, it is possible to provide an inexpensive configuration of the arrangement. In addition, control becomes easier due to the reduced number of channels.

In an embodiment, the first controllable channel comprises two diodes, one diode emitting green and/or yellow-green or yellow-green-white light and the other diode emitting red light. By means of the arrangement of the two diodes in the first channel, an effective compensation of the color locus shift is achieved with a low number of differing diodes.

In a further embodiment, the arrangement comprises a first diode of type A in a controllable channel. The type A diode is configured to emit green and/or green-white light. In addition, a second controllable channel is provided, a second and third diode being provided in the second controllable channel. The second diode is configured to emit red light. The third diode is configured to emit blue and/or blue-white light. By means of this arrangement, in particular a color locus shift for white light may be achieved in an effective manner.

In a further embodiment, the type A diode is configured to emit light with a color locus having a Cy value of more than 0.3 in the standard-color system. By using diodes with a Cy value higher than 0.3, a broad spectrum of white mixed light may be generated by means of the arrangement, the color locus shift of which may easily be compensated.

In a further embodiment, the type C diode is configured to emit light with a color locus having a Cy value of less than 0.540 in the standard-color system. In this manner, an arrangement is provided by means of which a broad spectrum of white mixed light is available, wherein additionally a compensation of the color locus shift may be achieved, wherein the color temperature of the mixed light exhibits a small shift.

Suitable for the arrangement are type B diodes which emit a light having a color locus with a Cx value in the standard-color system of more than 0.6.

In a further embodiment, the type B diode is configured to emit light with a wavelength in a range between 600 and 700 nm, particularly between 610 nm and 640 nm. By using the described type B, it is possible to efficiently generate the desired mixed light and to additionally provide a compensation of the color locus shift involving small current changes.

In a further embodiment, the arrangement comprises a chronometer which detects the operating time of the arrangement and transmits it to the drive circuit. Due to the detected operating time, the drive circuit changes at least the parameter of one channel. In this manner, a color locus shift caused by deterioration may easily be corrected. The use of the chronometer is inexpensive and does not require detection of the actual change of a diode's color locus shift by means of a color sensor.

In a further embodiment, the arrangement comprises a sensor detecting the color locus of at least one diode and transmitting it to the drive circuit. Due to the detected color locus shift, the drive circuit corrects the current supply to at least one of the control channels. In this manner, the color locus shift may be precisely compensated. Thus, an as low as possible change of the desired color locus of the mixed light may be achieved. In addition, an as low as possible change of the color temperature of the mixed light may be achieved.

In a further embodiment, the sensor may be configured to detect an operating parameter of at least one diode. An operating parameter may, e.g., be the temperature or the current of the diode. The detected operating parameter of the diode is transmitted to the drive circuit. Depending on the detected operating parameter, the drive circuit compensates the current supply in such a way that an undesired color locus shift is counteracted.

Depending on the chosen embodiment, a plurality of type B diodes and a plurality of type C diodes may be series-connected within the first channel. In addition, the diodes of the first channel may partially be connected in parallel.

Moreover, the diodes of the second channels may comprise a plurality of type A diodes and also a plurality of type B diodes, as well. Furthermore, the diodes of the second channel may partially be connected in parallel. A plurality of diodes has the advantage that the light flow may be increased and a desired color locus of the mixed light may be adjusted in a precise manner.

### BRIEF DESCRIPTION OF THE DRAWINGS

The above-described properties, features and advantages of the present invention as well as the manner in which they are achieved will become clearer in context with the following description of the embodiment examples explained in conjunction with the accompanying drawings, in which

FIG. 1 shows a schematic view of an arrangement for emitting mixed light by means of diodes,

FIG. 2 depicts a schematic view of the functionality of the arrangement of an embodiment example, and

FIG. 3 depicts the color locus space with the different types of diodes which may be used for configuring the arrangement.

### DETAILED DESCRIPTION OF ILLUSTRATIVE EMBODIMENTS

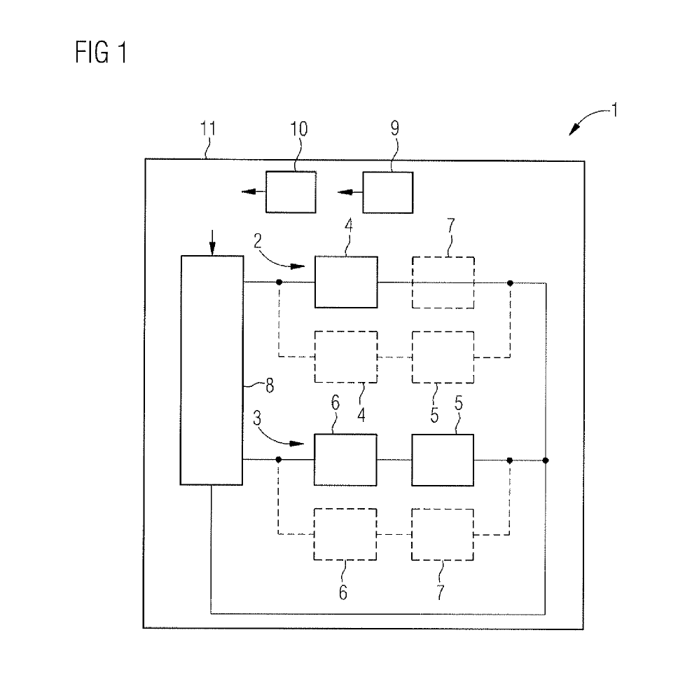

FIG. 1 schematically shows an arrangement 1 comprising a plurality of diodes 4, 5, 6, 7, and by means of which a white mixed light may be generated. The arrangement 1 comprises a carrier 11. A drive circuit 8 is arranged on the carrier 11. The drive circuit 8 supplies current to a first and a second channel 2, 3. In the first channel 2, at least one first type A diode 4 is arranged. Depending on the chosen embodiment, at least a fourth diode 7 of type B may be provided. In the second channel 3, at least one third type C diode 6 is arranged. In addition, at least one second type B diode 5 is arranged in the second channel 3. The drive circuit 8 is configured to supply different currents to the first and/or the second channel 2, 3.

In addition, depending on the chosen embodiment, the first channel 2 may also comprise a parallel connection of first and second diodes 4, 5, as indicated in FIG. 1 by means of dashed lines. In addition, the second channel 3 may also comprise a parallel connection of third and fourth diodes 5, 6. This is also shown in FIG. 1 as dashed lines.

In addition, the arrangement 1 may comprise a sensor 10. The sensor 10 may be a temperature sensor, a current sensor or a color sensor. The sensor 10 is connected to the drive circuit 8. In addition, a chronometer 9 may be provided for detecting the operating time of the arrangement 1. Depending on the chosen embodiment, the chronometer 9 may also be directly integrated into the drive circuit 8. The first type A diode 4 is configured to emit light with a color locus, the Cy value of which is more than 0.3 in the standard-color system, i.e., green and/or green-white light.

The second type B diode 5 is configured to emit red light. In addition, the second type B diode 5 is configured to emit light with a color locus, the Cx value of which is more than 0.6 in the standard-color system. For example, the wavelength emitted by type B is in a range between 600 and 700 nm, particularly between 610 nm and 640 nm.

The third type C diode 6 is configured to emit light with a color locus having a Cy value smaller than 0.540 in the standard-color system, i.e., blue and/or blue-white light. The further diode 7 is of type B. The type A diodes and the type C diodes may comprise a converter configured to shift the wavelength of at least a part of the light emitted by the diode. Thus, a desired wavelength may be set in a precise manner.

The color loci of the type A and the type C diodes are chosen in such a way that in an embodiment a type A diode has a Cy value larger than the type C diode in the standard-color system.

One property of diodes is that depending on operating parameters such as temperature, current or operating time, the color locus of the emitted light shifts. In order to maintain a desired color locus for the mixed light of the arrangement, it is advantageous to compensate the color locus shift. For this purpose, an operating parameter such as the temperature and/or the current of a diode and/or the color locus of the light emitted by the diode may be detected and transmitted to the drive circuit by means of the sensor 10. Depending on the transmitted value of the temperature and/or the current of the diode and/or the color locus, the drive circuit 8 may change the control of the channel(s) 2, 3 in such a way that the color locus shift is counteracted. Moreover, the operating time of the arrangement may be detected by means of the chronometer 9. The diodes also exhibit a color locus shift depending on the operating time. The operating time is transmitted to the drive circuit 8, as well. Depending on the detected operating time, the drive circuit 8 may change the control of the first and/or the second channel 2, 3, so that a color locus shift is counteracted. The drive circuit comprises tables or predetermined allocations to the operating parameters of the diodes such as current, temperature and or operating time of the diodes which is allocated to a change of the control, in particular of the current strength of the first and/or the second channel in order to counteract a color locus shift. The color locus shift depending on the temperature, current or operating time is known for the individual diode types. The corrections of the drive of the first and/or second channel are accordingly stored in the drive circuit 8. The correction also depends on the number of diodes of which type arranged in the first and/or in the second channel 2, 3. In general, a plurality of diodes of differing types may be arranged in the first and second channel. For example, 15 type A diodes and 5 type B diodes may be arranged in the first channel. In addition, e.g., 50 type C diodes and 10 type B diodes may be arranged in the second channel. In the described embodiment, the diodes of each channel are connected in series.

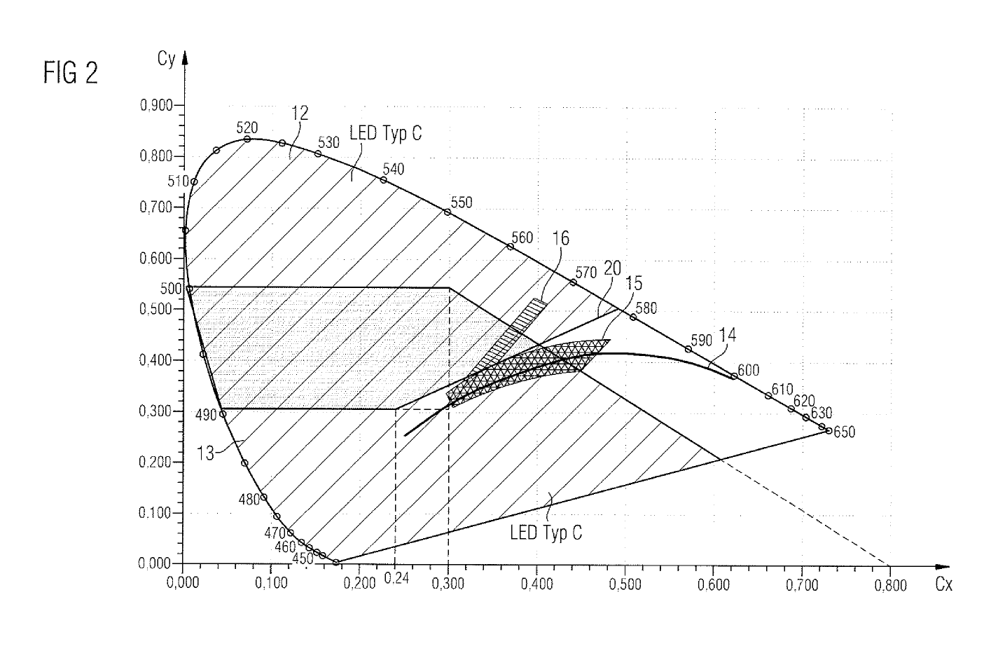

FIG. 2 depicts a CIE 1931 standard-color scheme, the Cx value being plotted on the x-axis and the Cy value being plotted on the y-axis. FIG. 2 shows a first region 12 of the color space showing the possible color loci of the type A diodes. The first region 12 may be limited by the Cy value being higher than 0.3. This applies to a Cx value region in a range of 0 to 0.24. Starting from a Cx value of 0.24, the Cy value for the first region 12 increases in a straight line and intersects the color space in the area of the 575 nm wavelength.

In addition, a second region 13 is indicated in the color space which contains the possible color loci for the C type. The second region 13 shows a maximum Cy value of 0.54 for Cx values smaller than 0.3. With a Cx value of more than 0.3, the Cy value falls in a second straight line 21 having a predetermined slope and intersects the color space at Cₓ=0.8.

The first and second region overlap in the area of Cy being higher than 0.3 and Cy being smaller than 0.55.

Furthermore, FIG. 2 shows a Planck curve 14 and the admissible color space 15 for white mixed light around the Planck curve. In addition, a color shift space 16 for a diode is depicted in which a color locus shift may occur, e.g., due to deterioration.

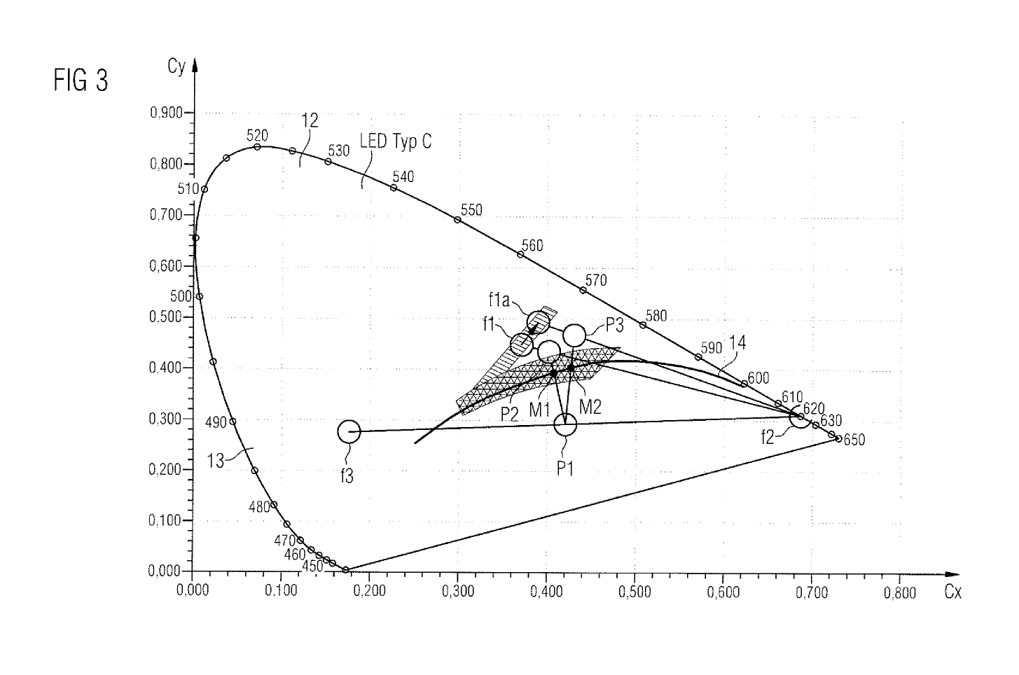

The arrangement 1 is a light-mixing source having two channels 2, 3 which may controlled separately from each other. Depending on at least one parameter such as temperature, current, color locus of the light emitted from the diode and on the operating time of the diode, at least one channel may be adjusted. In this context, at least three different types of LEDs having differing light colors are used in the following embodiment example. In the first channel 2, at least one first type A diode 4 and a second type B diode 5 are used. The color locus of the mixed light of the first channel 2 is referenced by F1 in FIG. 3. The color locus of the first diode 4 is indicated by f1, the color locus of the second and fourth diode 5, 7 is indicated by f2 and the color locus of the third diode 6 is indicated by f3. In the second channel, at least type B and type C diodes are used. The color locus of the mixed light of channel 2 is indicated by P2. At least the type A diode exhibits an undesired color-locus shift along a straight line 22.

FIG. 3 clearly shows the color locus shift f1 along the third straight line 22. For example, f1 is depicted for 0 operating hours of the diode. In addition, the color locus f1a is depicted for 50,000 operating hours. After 50,000 operating hours, the light of the first type A diode exhibits a color locus which is shifted upwards along a third straight line 22. As a result, the mixed light emitted by the first channel 2 shifts from P2 to P3. In order to counteract this, a change of the current feed of the first and/or the second channel 2, 3 is carried out. In the present example, the second channel is supplied with more current. Thereby, the color locus shift of the first type A diode 4 is compensated with a higher brightness of the third and fourth diodes 6, 7 of type C and D. In the new state, the mixed light of the arrangement 1 comprises a color locus M1. After 50,0000 operating hours and due to a compensating control, the arrangement 1 comprises a mixed light with a second color locus M2. The first and second color locus M1 and M2 are located within the color space 15 admissible for white light around the Planck curve 14. By means of the described arrangement, a white light with a color temperature of 4,000 K may be generated in the new arrangement 1. Even after a color locus shift from color locus f1 to f1a after 50,000 hours of operating time of the type A diode, a corresponding drive of the first and/or second channel 2, 3 may generate white light with a color temperature of 3,700 K by means of the arrangement 1. For this purpose, the first current in the second channel is increased accordingly. Thus, the color temperature of the mixed light emitted by arrangement 1 may be kept relatively consistent.

By means of the described combination of type A and preferably type B diodes in a first channel and the type C and B diodes in a second channel, the color locus shift may be counteracted in spite of the color locus shift of type A and/or of type B. Furthermore, the color locus shift may be compensated with a low loss of color temperature of the white light. This is also achieved when using type A and type B diodes in the first channel.

The described two-channel solution for channels which may be controlled in different manners offers the advantage of low costs when compared to a three-channel solution. The color locus shift may be compensated by suitably choosing the color loci for the used type A, B, C diodes and the used diode combination in the channels 2, 3. The compensation of the color locus shift is particularly significant in case of a color locus shift occurring during operating time, i.e., due to deterioration.

By accordingly determining the distribution of the type A, B and C diodes to the at least two channels 2, 3, a color locus shift may be compensated by a correspondingly different drive of the two channels.

In an example the arrangement 1 comprises fifteen type B diodes and five type C diodes which are series-connected in the second channel 3. In the first channel 2, 50 type A diodes and 10 type B diodes are connected in series. Depending on the chosen embodiment, other combinations of type A, B and C diodes may be used, as well. The correcting factors for the currents of the first and second channel are stored in the drive circuit 8 depending on the number of diode types and on the distribution to the first and second channel depending on the operating parameters such as diode temperature, diode current, operating time of the diode and/or color locus shift.

Although the present invention has been depicted and described in detail by means of the preferred embodiment example, the present invention is not limited to the disclosed examples and other variants may be devised by the person skilled in the art without exceeding the scope of protection of the present invention.

1-17. (canceled)

18. An arrangement for emitting mixed light, the arrangement comprising:
a type A diode, wherein the type A is a diode configured to emit green and/or green-white light;
a type B diode, wherein the type B is a diode configured to emit red light;
a type C diode connected in series with the type B diode, wherein the type C is a diode configured to emit blue and/or blue-white light; and
a drive circuit configured to supply the type A diode with current via a first channel, configured to supply the series-connected type B and type C diodes with current via a second channel, wherein the drive circuit is configured to change the current supplied to the first or second channel depending on an operating parameter of at least one diode so as to counteract a color locus shift of a diode.

19. The arrangement of claim 18, wherein the operating parameter is an operating time of the diode.

20. The arrangement of claim 19, further comprising a chronometer configured to detect the operating time of the type A, type B and type C diodes.

21. The arrangement of claim 19, wherein the drive circuit comprises tables or predetermined allocations to an operating time of the diodes, which are allocated to a change of the drive.

22. The arrangement of claim 21, wherein the tables or predetermined allocations are allocated to current strength of the first and/or second channel in order to counteract the color locus shift.

23. The arrangement of claim 18, further comprising a fourth diode is provided that is electrically series-connected to the type A diode in the first channel, the fourth diode configured to emit red light.

24. The arrangement of claim 18, wherein the type A diode is configured to emit light with a color locus that has a Cy value of more than 0.3 in a standard-color system.

25. The arrangement of claim 18, wherein the type C diode is configured to emit light with a color locus that has a Cy value of less than 0.540 in a standard-color system.

26. The arrangement of claim 18, wherein the type B diode is configured to emit light with a color locus that has a Cx value of more than 0.400 in a standard-color system.

27. The arrangement of claim 18, wherein the operating parameters are a temperature, a current or a color locus of at least one diode.

28. The arrangement of claim 18, wherein the type B diode is configured to emit a light having a wavelength in a range between 610 nm and 640 nm.

29. An arrangement for emitting mixed light, the arrangement comprising:
a type A diode, wherein the type A is a diode configured to emit green and/or green-white light;
a type B diode, wherein the type B is a diode configured to emit red light;
a type C diode connected in series with the type B diode, wherein the type C is a diode configured to emit blue and/or blue-white light; and
a drive circuit configured to supply the type A diode with current via a first channel, configured to supply the series-connected type B and type C diodes with current via a second channel, wherein the drive circuit is configured to change the current supply for the first or second channel depending on an operating time of at least one diode so as to counteract a color locus shift of a diode.

30. A method for compensating a change of a color locus of a mixed light emitted from an arrangement having a plurality of diodes, wherein the method comprises:
supplying a first diode with current via a first channel of a drive circuit, the first diode being a type A diode, wherein type A diodes are diodes configured to emit green and/or green-white light;
supplying a second and a third diode that are electrically series-connected with current via a second channel of the drive circuit, the second diode being a type B diode and the third diode being a type C diode, wherein type B diodes are configured to emit red light and type C diodes are configured to emit blue and/or blue-white light; and
changing the current supplied to the first and/or the second channel depending on an operating parameter of at least one of the first, second and third diodes in order to counteract a color locus shift of the mixed light.

31. The method of claim 30, wherein the operating parameter is an operating time of the diode.

32. The method of claim 30, wherein the operating parameter is a temperature, a current and/or a color locus of the emitted light of a diode.

33. The method of claim 30, further comprising supplying a fourth diode with current via the first channel, the fourth diode being electrically series-connected to the first diode, wherein the fourth diode is of type B, configured to emit red light.

34. The method of claim 30, wherein the type A diode is emits light with a color locus which has a Cy value of more than 0.3 in a standard-color system.

35. The method of claim 30, wherein the type C diode emits light with a color locus has a Cy value of less than 0.540 which in a standard-color system.

36. The method of claim 30, wherein the type B diode emits light with a color locus which has a Cx value of more than 0.400 in a standard-color system.

37. The method of claim 30, wherein the type B diode emits light at a wavelength in a range between 600 and 700 nm.
